(19) United States
(12) Patent Application Publication
(10) Pub. No.: US 2016/0316767 A1
(43) Pub. Date: Nov. 3, 2016

(54) BAKING DEVICE AND REMOVAL DEVICE

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); REINHART ADAM, WIEN (AT)

(21) Appl. No.: 15/112,225

(22) PCT Filed: Jan. 12, 2015
(86) PCT No.: PCT/EP2015/050411

§ 371 Date: Jul. 18, 2016

(30) Foreign Application Priority Data
Jan. 17, 2014 (EP) PCT/EP2014/050884
Aug. 12, 2014 (AT) A 628/2014

(51) Int. Cl. A21B 3/18; B65G 47/52; A21D 13/00; A21B 5/02

(52) U.S. Cl. CPC A21B 3/18; A21B 5/02; B65G 47/52; A21D 13/0022; B65G 2201/0202

(57) ABSTRACT

A baking oven, a method and a removal device are provided for the continuous removal of filled bakery products from baking molds moved along a conveying surface and for the continuous transport of the bakery products to a dispensing surface. The removal device has a rotary unit, which is mounted rotatably about an axis of rotation, which can be driven and which is optionally driven. A first removal element is provided on the rotary unit and can be co-rotated with the rotary unit. The first removal element is mounted movably, in particular pivotably about a first pivot axis, with respect to the rotary unit, and wherein a second removal element is provided on the rotary unit and can be co-rotated with the rotary unit.

The invention relates to a baking device and/or a removal device for the continuous removal of cream-filled bakery products from baking moulds moved along a conveying surface and for the continuous transport of the bakery products to a dispensing surface comprising a rotary unit, which is mounted rotatably about an axis of rotation, which can be driven and which is optionally driven, wherein a first removal element is provided on the rotary unit and can be co-rotated with the rotary unit, wherein the first removal element is mounted movably, in particular pivotably about a first pivot axis, with respect to the rotary unit so that the first removal element can be brought from a retracted position into an outwardly extended position.

Industrial baking ovens for the continuous production of different bakery products in baking tongs moved along an endless conveyor are known according to the prior art. In particular, baking ovens are known for the production of wafer products having a soft consistency, such as for example for the production of so-called waffles. These bakery products are baked in baking moulds which can be opened and closed and are removed from the baking moulds by a product removal device. Conventional product removal devices for such products comprise a drum from which needles bent in the direction of rotation can be extended. These bent needles are pricked into the baked products located in the baking moulds. Through further rotation of the drum the products pricked by the needles are removed from the baking mould and conveyed further to a dispensing surface. In order to effect an impaling or release of the bakery products, according to the prior art the needles are arranged to be retractable and extendable. In order to be able to remove the bakery products from the baking moulds, without risking an undesired breakout of parts of the bakery products in so doing, according to the prior art the needles are pierced through a majority of the bakery product.

A disadvantage with this design is that it cannot be used for filled bakery products such as, for example, for cream-filled bakery products, since the needles would perforate the cream space with the result that the cream can subsequently escape and with the result that furthermore, the needle-shaped removal bodies are contaminated with the cream. Furthermore, in conventional needle removal devices there is the fundamental disadvantage that the needles must be pricked very deeply into the product.

It is now the object of the invention to overcome the disadvantages of the prior art. This includes in particular that the bakery products can be removed gently and efficiently from the baking moulds. Furthermore, this comprises in particular the fact that the necessary puncture depth of the needles is reduced so that, for example, a centrally arranged filling or the filling space thereof is not perforated during the removal.

The object according to the invention is solved in particular by the features of the independent patent claims.

In particular, the invention relates to a baking device and a removal device for bakery products such as, in particular waffles, filled waffles or soft cakes baked in baking tongs which can also be filled.

The fillings of these bakery products comprise, for example, creams such as fat creams, chocolate creams, vanilla creams, fruit creams, confitures and/or similar creams. This filling is preferably arranged centrally in a filling space or a filling chamber and surrounded by a baked dough or a baked baking mass.

In particular, the invention relates to a removal device for the continuous removal of filled bakery products from baking moulds moved along a conveying surface and for the continuous transport of the bakery products to a dispensing surface comprising a rotary unit, which is mounted rotatably about an axis of rotation, which can be driven and which is optionally driven, wherein a first removal element is provided on the rotary unit and can be co-rotated with the rotary unit, wherein the first removal element is mounted movably, in particular pivotably about a first pivot axis, with respect to the rotary unit, so that the first removal element can be brought from a retracted position into an outwardly extended position, wherein a second removal element is provided on the rotary unit and can be co-rotated with the rotary unit, wherein the second removal element is mounted movably, in particular pivotably about a second pivot axis, with respect to the rotary unit, so that the second removal element can be brought from a retracted position into an outwardly extended position and/or wherein the first removal element and the second removal element in pairs form a removal gripper.

Optionally it is provided that one of the two removal elements is provided with a tip at the free end thereof or that both of the removal elements are each provided with a tip at the free ends thereof, wherein the tip is adapted to prick into the bakery product to be removed.

Optionally it is provided that the distance between the tip of the first removal element and the tip of the second removal element is shorter in the extended position than in the retracted position.

Optionally it is provided that the distance between the tip of the first removal element and the tip of the second removal element in the extended position is greater than zero so that the tips neither cross nor contact during extension and in particular are pricked into the bakery product at a distance from the cream filling of the bakery product.

Optionally it is provided that the removal gripper comprises a first removal element and a second removal element and that one of the two removal elements is movable and in particular extendable in the direction of rotation of the rotary unit and that the other removal element is movable and in particular extendable contrary to the direction of rotation of the rotary unit.

Optionally it is provided that the removal gripper comprises a first removal element and a second removal element and that one of the two removal elements and in particular the tip thereof in its extended position points in the direction of rotation of the rotary unit and that the other removal element and in particular the tip thereof in its extended position points contrary to the direction of rotation of the rotary unit so that the two removal elements and in particular the tips thereof point towards one another in the extended position.

Optionally it is provided that the removal element is movable and in particular extendable substantially along its principal direction of extension or that the removal elements are movable or pivotable and in particular extendable substantially along their principal directions of extension.

Optionally it is provided that the tip of the removal element in the extended position points substantially in the tangential direction of the rotary unit or that the tips of the removal elements in their extended position point substantially in the tangential direction of the rotary unit.

Optionally it is provided that the first removal element is disposed pivotably about a first pivot axis with respect to the rotary unit, wherein the first pivot axis is located at a distance from the axis of rotation of the rotary unit on the rotary unit and/or that the second removal element is disposed pivotably about a second pivot axis with respect to the rotary unit, wherein the second pivot axis is located at a distance from the axis of rotation of the rotary unit on the rotary unit.

Optionally it is provided that the first pivot axis and/or the second pivot axis is or are located parallel at a distance from the axis of rotation of the rotary unit so that the removal elements of the removal gripper are disposed movably with respect to one another in a gripper-like manner along a normal plane of the axis of rotation of the rotary unit in opposite directions and that the removal elements of the removal gripper optionally run along a normal plane of the axis of rotation of the rotary unit.

Optionally it is provided that the first pivot axis and the second pivot axis are disposed parallel at a distance from one another on the rotary unit.

Optionally it is provided that a control device is provided for movement of the removal elements from the retracted position into the outwardly extended position and from the outwardly extended position into the retracted position and for opening and closing the removal gripper.

Optionally it is provided that the control device comprises a first rotary link with a first control cam and a first scanning element guided along the first control cam and that the first scanning element has a normal distance and in particular a lag with respect to the first pivot axis and is connected to the first removal element so that as a result of movement of the first scanning element the first removal element is movable from the retracted position into the outwardly extended position and from the outwardly extended position into the retracted position.

Optionally it is provided that the control device comprises a second rotary link with a second control cam and a second scanning element guided along the second control cam and that the second scanning element has a normal distance and in particular a lag with respect to the second pivot axis and is connected to the second removal element so that as a result of movement of the second scanning element the second removal element is movable from the retracted position into the outwardly extended position and from the outwardly extended position into the retracted position.

Optionally it is provided that the first control cam has a first control cam section and a second control cam section, wherein the mean radius or the radius of the first control cam section is smaller than the mean radius or the radius of the second control cam section, that at the transition from the first control cam section to the second control cam section a first transition section connecting the two control cam sections is provided and that at the transition from the second control cam section to the first control cam section a second transition section connecting the two control cam sections is provided.

Optionally it is provided that the second control cam has a first control cam section and a second control cam section, wherein the mean radius or the radius of the first control cam section is smaller than the mean radius or the radius of the second control cam section, that at the transition from the first control cam section to the second control cam section a first transition section connecting the two control cam sections is provided and that at the transition from the second control cam section to the first control cam section a second transition section connecting the two control cam sections is provided.

Optionally it is provided that the first rotary link and the second rotary link are disposed parallel to one another.

Optionally it is provided that for removal of the bakery products, a transition section of the first control cam and a transition section of the second control cam are disposed offset with respect to one another in the circumferential direction of the rotary unit, wherein the distance of the offset substantially corresponds to the distance of the first scanning element from the second scanning element so that the two removal elements of a removal gripper are moved or pivoted simultaneously with respect to one another in order to close the removal gripper.

Optionally it is provided that for dispensing of the bakery products onto the dispensing surface a transition section of the first control cam and a transition section of the second control cam are disposed with respect to one another in the circumferential direction of the rotary unit in such a manner that the front removal element in the direction of rotation of the rotary unit will be or is moved before the rear removal element in the direction of rotation of the rotary frame from the outwardly extended position into the retracted position.

Optionally it is provided that a plurality of first removal elements are connected to one another via a first removal bar and that a plurality of second removal elements are connected to one another via a second removal bar.

Optionally it is provided that a plurality of first removal elements are connected to one another via a first removal bar, that a plurality of second removal elements are connected to one another via a second removal bar and that the two removal bars are disposed parallel at a distance from one another and parallel at a distance from the axis of rotation of the rotary unit.

Optionally it is provided that a plurality of first removal elements are connected to one another via a first removal bar, that a plurality of second removal elements are connected to one another via a second removal bar, that the first removal bar is connected pivotably about the first pivot axis to the rotary unit and is pivotable with respect to the rotary unit by means of the first scanning element of the control device and that the second removal bar is connected pivotably about the second pivot axis to the rotary unit and is pivotable with respect to the rotary unit by means of the second scanning element of the control device.

Optionally it is provided that the first removal elements connected and driven by means of the first removal bar and the second removal elements connected and driven by means of the second removal bar together form a bar gripper for the removal of a plurality of bakery products.

Optionally it is provided that the first removal elements connected and driven by means of the first removal bar and the second removal elements connected and driven by means of the second removal bar together form a bar gripper for the removal of a plurality of bakery products and that a plurality of bar grippers are provided along the circumferential direction of the rotary unit.

Optionally it is provided that in the outer region of the rotary unit, at least one plate body is provided which is rigidly connected to the rotary unit, wherein the plate body has openings for passing through the removal elements.

Optionally it is provided that in the outer region of the rotary unit at least one plate body is provided which is rigidly connected to the rotary unit, wherein the plate body has openings for passing through the removal elements, and that a plurality of plate bodies are provided which together form a housing or that a single curved plate body forms a housing.

Optionally it is provided that the housing is configured to be cylindrical or drum-shaped, wherein the axis of symmetry or the axis of rotation of the housing coincides with the axis of rotation of the rotary unit.

Optionally it is provided that the two rotary links are disposed on both sides of the rotary unit in a fixed position, in particular rigidly on a fixedly arranged machine frame.

Optionally the invention relates to a baking device for the production of bakery products, in particular for the production of cream-filled bakery products, wherein the baking device comprises baking moulds comprising baking tongs which can be opened and closed, which are movable on a continuously moving endless conveyor circulating in the longitudinal direction of a machine frame of the baking oven along a conveying surface from a loading device through a baking chamber and to a removal device, wherein a dispensing surface is provided for removal of the bakery products from the baking device, and wherein a removal device is provided for the continuous removal of the cream-filled bakery products from the baking moulds and for the continuous transport of the bakery products to the dispensing surface according to the preceding description.

Optionally it is provided that the rotation of the rotary unit is synchronized with the movement of the baking moulds so that the speed of the removal elements in the region of the baking moulds is substantially the same as the speed of the baking moulds.

Optionally it is provided that the rotary link(s) of the removal device are connected rigidly to the machine frame.

Optionally it is provided that the removal grippers are closed in the region directly upstream of the dispensing surface and that the removal grippers are open in the region directly downstream of the dispensing surface so that one or more bakery products are dispensed by the removal grippers onto the dispensing surface.

Optionally it is provided that the removal grippers are open in the region directly upstream of the baking mould and that the removal grippers are closed in the region directly downstream of the baking mould so that one or more bakery products are removed by one or more removal grippers from the baking mould.

Optionally the invention relates to a method for the production and/or continuous removal of filled bakery products from baking moulds moved along a conveying surface and for the continuous transport of bakery products to a dispensing surface comprising the following steps:
turning the rotary unit about its axis of rotation;
retracting two removal elements into a retracted position;
turning the removal elements in the direction of that baking mould from which the bakery product is to be removed;
actuating the control device when the removal elements have arrived in the region of this baking mould so that the removal elements are moved from the retracted position into an outwardly extended position;
pricking the tip of at least one removal element into the bakery product through movement of the removal element, where preferably two removal elements on both sides of the bakery product are pricked into this;
stopping the pricking movement of the removal elements before these penetrate into the filling space so that the filling space is not perforated,
turning the rotary unit further so that the bakery product is raised on the orbit of the removal elements and in particular is removed from the baking mould,
conveying the removed bakery product further along this orbit until it is located in the region of the dispensing surface;
retracting the removal elements into a retracted position whereby the tip of the removal element or the tips of the removal elements are pulled from the bakery product so that the bakery product is released from the rotary unit and it can be removed over the dispensing surface.

Optionally it is provided that
in a first step a dough or a baking mass is applied to two baking plates of an opened baking tong,
in a following step, a filling such as, for example, a cream, a fat cream or a confiture is applied centrally to at least one baking plate of the baking tong and in particular to a dough applied to the baking plate or to a baking mass applied to the baking plate,
in a following step, the baking tong is closed, whereby the filling is enclosed between the two dough moulds or baking mass moulds,
in a subsequent step the two dough moulds or baking mass moulds are joined by baking in a baking chamber,
and the filled bakery products thus formed with a filling space disposed therein are removed.

Optionally the invention relates to a baking device and/or a removal device, wherein the removal device comprises a removal gripper, wherein the removal gripper comprises removal elements acting against one another in pairs, wherein the removal elements are adapted to prick into the bakery product to be removed from two sides. Optionally it is provided in all embodiments that the tips of the removal elements of a removal gripper have a distance from one another in the closed position. Preferably this distance is greater than the size of the filling space of the bakery product disposed between the removal elements. This prevents one of the two removal elements from pricking into the filling space.

Preferably the removal device and the baking device are adapted for the industrial production of bakery products, where the production and the removal take place continuously and where the removal device and/or the baking device can be used “in-line” in an industrial system for the production of bakery products.

The removal device preferably comprises a first removal element and a second removal element. The two removal elements are arranged movably on a rotatable rotary unit. A control device is optionally provided for movement of the removal elements. The two removal elements cooperate as a removal gripper which can be closed and opened. The movement of the removal elements or the opening and closing of the removal gripper is preferably accomplished by means of a control device. By means of this control device, an opening or closing can be effected, for example, depending on the position of the removal gripper. For example, the removal gripper is opened in the region of the dispensing surface in order to deposit the bakery product on the dispensing surface. For example, the removal gripper is closed in the region of the baking moulds in order to grip the bakery product and remove it from the baking mould. In particular, the control device is configured as a rotary link. By means of this rotary link, an opening and closing of the removal gripper can be effected over certain regions of the rotation of the rotary frame. In that region in which the bakery product is fixed to the rotary unit via the removal gripper, the removal gripper is preferably closed. In that region in which no bakery product is connected to the rotary unit, the removal gripper is preferably opened. As a result of this opening and closing of the removal gripper, a bakery product can be removed from the moving baking moulds and transferred continuously to the dispensing surface. Optionally the baking moulds are moved continuously during production of the bakery products and during removal. Optionally the rotary unit for removal of the bakery products from the baking moulds is moved continuously, in particular turned continuously.

The axis of rotation of the rotary unit is in particular disposed in such a manner that it is possible for the bakery products to be removed by the removal gripper or grippers. Preferably it is provided that the removal grippers or that the removal gripper in the region of the baking mould from which the bakery product is to be removed has the same speed and, at least in sections or at certain points, has the same direction of movement as the bakery product. In particular, the direction of movement of the bakery products can be a tangent to the movement curve of the removal grippers.

Optionally it is provided that on both sides of the rotary unit, respectively one rotary link is provided. In this embodiment two rotary links are provided where one rotary link is adapted for control of the first removal elements and a second rotary link is adapted for control of the second removal elements.

Optionally in all embodiments the removal gripper is closed between the position in the region of the baking mould and the dispensing surface so that bakery products can be removed, conveyed and dispensed.

The invention is described further hereinafter with reference to specific exemplary embodiments and with reference to the figures.

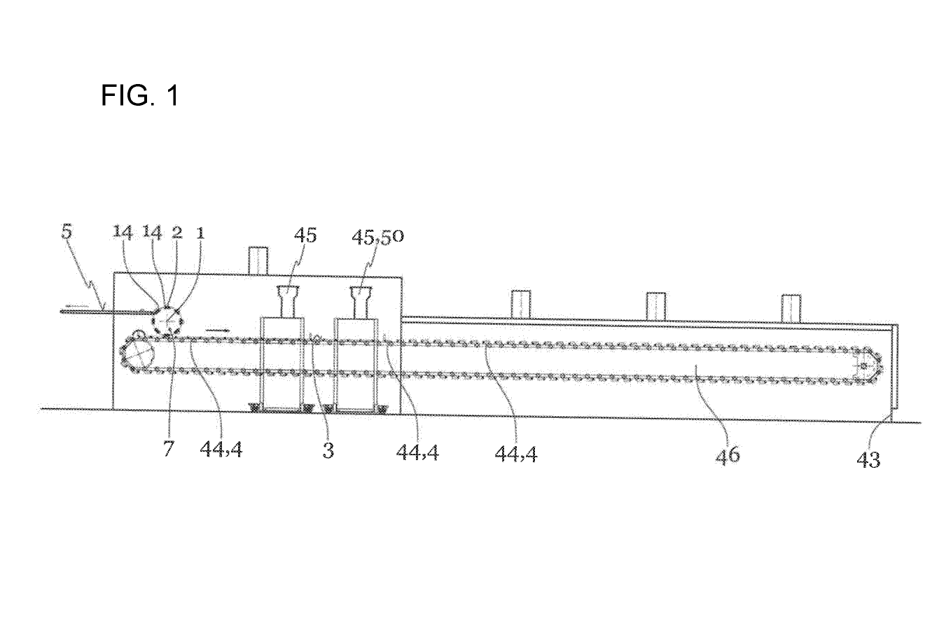

FIG. 1 shows a schematic side view of a possible embodiment of a baking machine.

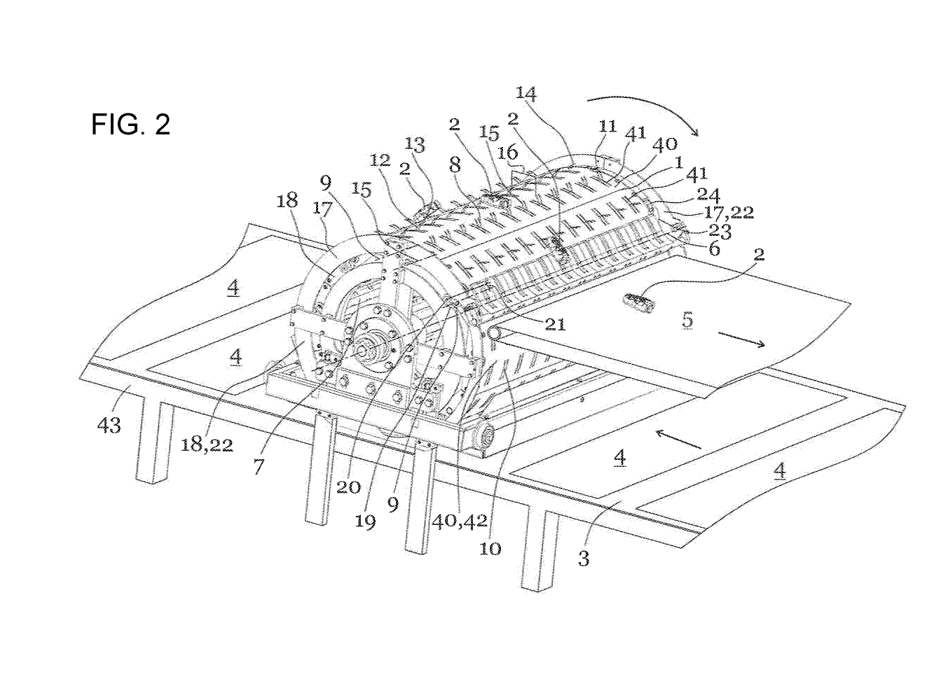

FIG. 2 shows a schematic oblique view of a detail of a baking machine according to the invention comprising a removal device according to the invention.

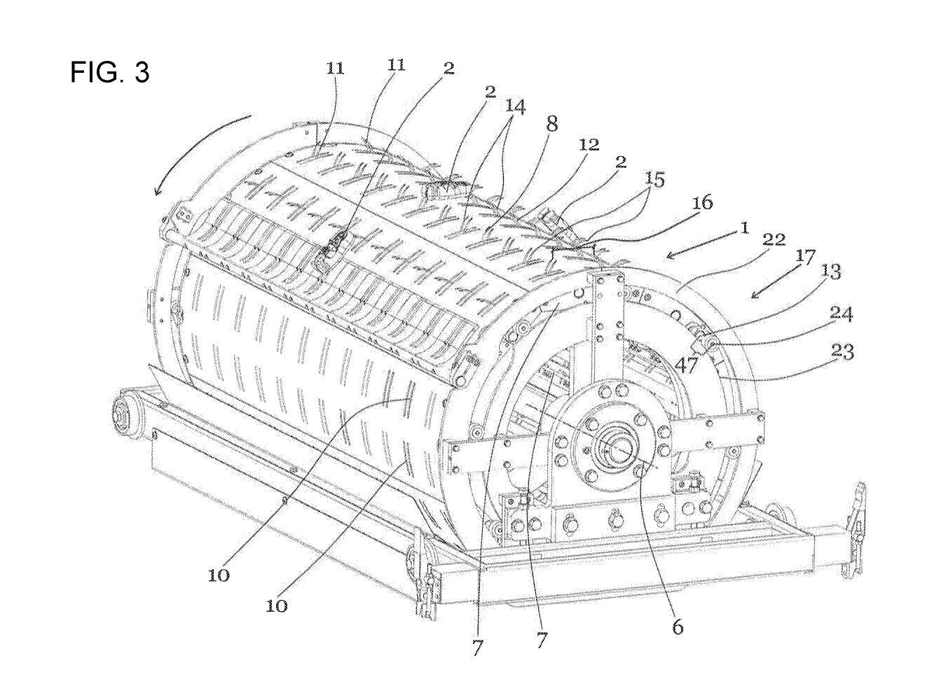

FIG. 3 shows a schematic oblique view of a removal device according to FIG. 2 but from the other side.

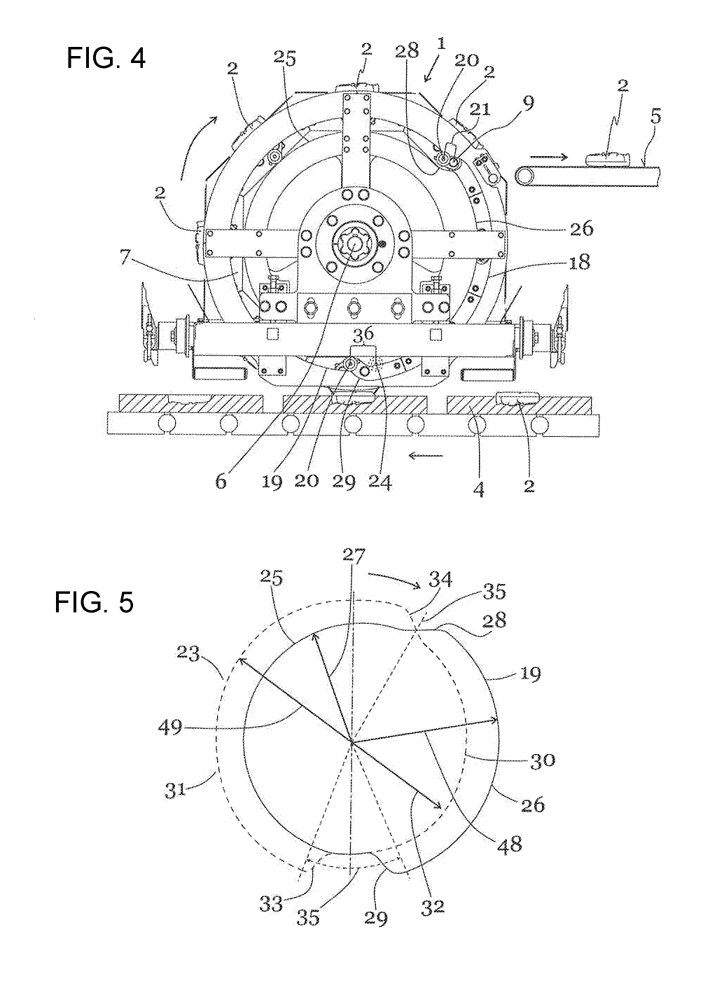

FIG. 4 shows a schematic side view which is shown partially cutaway.

FIG. 5 shows a schematic view of a possible embodiment of the control cams of the rotary links.

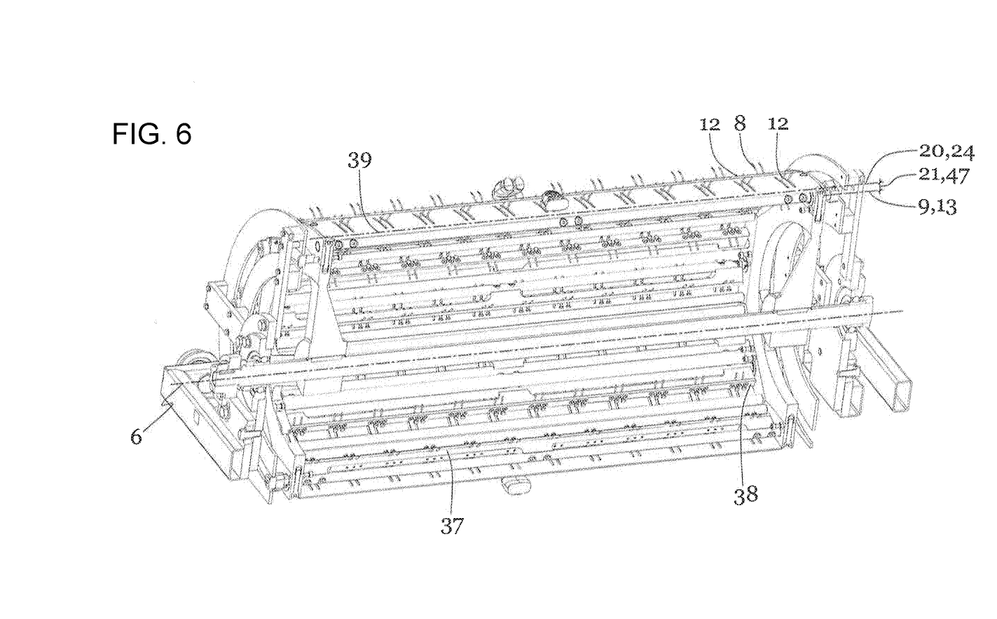

FIG. 6 shows a sectional view of a removal device according to the invention.

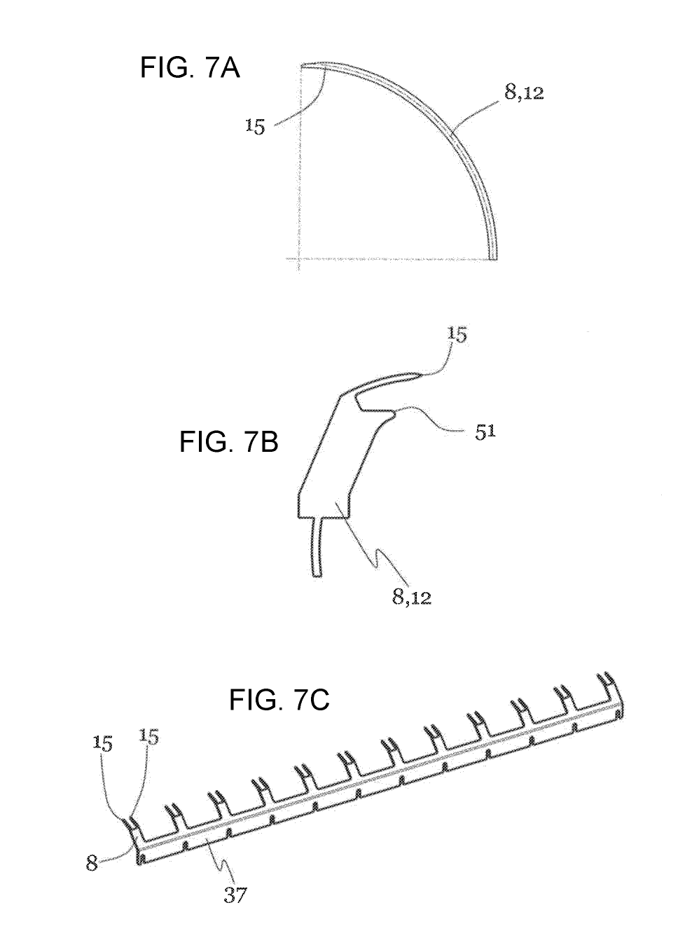

FIGS. 7a, 7b and 7c show various embodiments of possible removal elements or possible removal bars.

FIG. 1 shows a side view of a baking device, where the baking device is adapted for the production of bakery products and comprises baking tongs 44 which can be opened and closed, which are moved in the longitudinal direction of a machine frame 43 along an endless conveyor through the baking device.

The endless conveyor and the movement of the baking tongs is accomplished in particular along a conveying surface 3. Preferably two conveying surfaces 3 are provided: a lower conveying surface and an upper conveying surface, where the baking tongs are moved from the upper conveying surface to a front deflection point and then again to the upper conveying surface. The baking tongs 44 preferably form baking moulds 4. The bakery products 2 are baked in these baking moulds. A loading device 45, a device for closing the baking tongs 44, a baking chamber 46, a device for opening the baking tongs 44 and a product removal device are provided consecutively along the conveying surface. Preferably the product removal device is configured as removal device 1 according to the invention. Optionally the loading device 45 comprises a filling device 50. In this filling device 50 a filling for the bakery product, for example a cream, a vanilla cream, a chocolate cream, similar fat creams or a confiture is introduced into the baking mould 4. The filling is preferably provided centrally in the bakery product 2 and forms a central cream space or filling space separated by the dough portion of the bakery product. Preferably the device according to the invention is configured in such a manner that bakery products 2 can be removed from the baking mould 4 without perforation of this filling space.

The removal device 1 preferably comprises a rotary unit 7. This rotary unit is arranged rotatably. In the present embodiment, the axis of rotation of the rotary unit 7 preferably runs horizontally. In all embodiments the axis of rotation can run substantially horizontally and normally to the conveying direction of the baking mould(s) 4. As a result of rotation of the rotary unit 7, removal grippers 14 are co-rotated with the rotary unit. By controlling these removal grippers 14, respectively one or more bakery products 2 can be removed from the baking mould 4. Furthermore, the bakery products 2 are conveyed from the baking mould 4 to a dispensing surface 5. On this dispensing surface 5 the bakery products 2 can be transported further and in particular removed.

Optionally in all embodiments a plurality of baking moulds 4 can be provided per baking tong 44. These baking moulds 4 can be arranged adjacent to one another, for example, normal to the conveying direction of the baking tongs. By providing a plurality of removal grippers 14 on a rotary unit 7, a plurality of bakery products can be removed simultaneously from the baking tongs 44 containing a plurality of baking moulds 4.

FIG. 2 shows a schematic oblique view of a removal device according to the invention and a baking device according to the invention. The conveying direction of the baking tongs and the direction of rotation of the rotary unit 7 are indicated schematically by arrows. The baking device according to the invention comprises a conveying surface 3 for baking moulds 4, where the baking moulds and the baking machine are only depicted schematically. By means of the removal device 1, bakery products 2 can be transferred from the baking moulds 4 to a dispensing surface 5. In all embodiments this dispensing surface 5 can be configured, for example, as an endless conveyor. The rotary unit 7 is disposed rotatably about an axis of rotation 6, where this axis of rotation 6 is for example or preferably arranged horizontally and normally to the conveying direction of the baking moulds. In particular, in all embodiments the axis of rotations is preferably disposed in such a manner that the removal grippers 14 provided on the rotary unit 7 for removal of the bakery products 2 in the region of the baking moulds 4 have the same speed and direction of movement as the baking moulds 4. In the present embodiment, the conveying direction of the baking moulds 4 substantially corresponds to the tangent of the movement of the removal grippers 14. As a result, a bakery product 2 can in particular be gripped at the lower dead point of the rotary unit 7 and removed from the baking mould 4 along the direction of rotation of the rotary unit 7.

The removal gripper 14 preferably comprises a plurality of removal elements. In particular, an exemplary removal gripper 14 comprises a first removal element 8 and a second removal element 12. The two removal elements are provided movably, preferably pivotably, on the rotary unit 7. In particular, the first removal element 8 is pivotable about a first pivot axis 9 and the second removal element 12 is pivotable about a second pivot axis 13. As a result of the movability, the removal elements 8, 12 can be brought from a retracted position 10 into an extended position 11. The pivot axes are preferably disposed rigidly with respect to the rotary unit and are thereby co-rotated with this. At least one of the removal elements 8, 12 has a tip 15. Preferably both removal elements 8, 12 have at least one tip 15. This tip or these tips 15 are adapted to engage, in particular penetrate, in the bakery products 2 in order to enable a secure holding and removal of the bakery products 2 from the baking mould 4. In particular, in the extended position 11 the distance 16 between the tips 15 is shorter than in the retracted position. During extension of the removal elements 8, 12, the tips 15 of the removal elements 8, 12 are therefore preferably moved towards one another. As a result, the removal gripper 14 is optionally pricked into the bakery product 2 on both sides. The movement of the removal elements 8, 12 or the removal gripper 14 is preferably accomplished by means of a control device 17. In all embodiments, the control device 17 can, for example, comprise movable elements which bring about an opening and closing of the removal gripper 14 or the removal grippers 14 by means of a suitable temporal and local control.

In the present embodiment, the control device 17 comprises at least one first rotary link 18. Optionally the control device 17 of the removal device 1, as in the present embodiment, also comprises a second rotary link 22. The control device 17 comprises in particular in the region of its first rotary link 18 a first control cam 19. This control cam 19 is scanned by a first scanning element 20. The first scanning element 20 optionally has a normal distance 21 from the first pivot axis 9. Due to different distances of the control cams 19 to the axis of rotation 16, during rotation of the rotary unit 7 the scanning element 20 is moved in the radial direction. This movement is used to move the first removal elements 8 and in particular to move from a retracted position 10 into an extended position 11 or conversely. The same preferably also applies to the second control cam 23 with its second scanning element 24 which scans the second control cam 23. Preferably in all embodiments the removal device 1 comprises one or more plate bodies 40. These plate bodies 40 preferably form a housing 42. The plate bodies 40 or the housing 42 optionally have openings 41. The removal elements 8, 12 can be guided through these openings 41 and in particular extended from their retracted position 10 into their extended position 11. In the extended position preferably in all embodiments, the removal elements 8, 12 project beyond the outer side of the plate bodies 40 or the housing 42 so that the bakery products 2 can be removed from the baking moulds 4.

The baking device according to the invention preferably comprises a machine frame 43. The machine frame 43 is preferably rigidly connected to the rotary link 18, 22. In particular, the control cam 19, 23 is connected torsionally rigidly to its machine frame 43. The movement of the rotary unit 7 with respect to the machine frame 43 thus brings about a relative movement of the scanning element 20, 24 with respect to the control cam 19, 23. The removal elements 8, 12 are thereby moved. This is achieved in particular as a result of the scanning elements 20, 24 having a normal distance 21, 47 from the pivot axes 9, 13 of the removal elements.

FIG. 3 shows another view of a removal device 1, in particular another view of the removal device 1 from FIG. 2 but viewed from the opposite side. The features of FIG. 3 are obtained in particular also from the description of FIG. 2 and optionally from the reference list. The removal device 1 comprises removal grippers 14 for removal of the bakery products 2. The removal grippers 14 comprise removal elements 8, 12 cooperating in pairs. The second removal elements 12 are moved by means of the control device 17, in particular by means of the second rotary link 22, the second scanning elements 24 and the second control cam 23. By this means they can be brought from a retracted position 10 into an extended position 11. The rotary unit 7 is again disposed rotatably about an axis of rotation 6. The individual removal elements 8, 12 are arranged moveably, in particular pivotably about a respective pivot axis 9, 13. The removal grippers 14 are formed by the removal elements 8, 12. Preferably the removal grippers have one or more tips 15. The distance 16 between the tips 15 can be varied by moving the removal gripper 14 or the removal elements 8, 12, in particular in order to prick into the bakery product 2.

The second scanning element 24 preferably has a normal distance 47 from the second pivot axis 13. As a result of this normal distance, a pivoting of the second removal elements 12 about the pivot axis 13 can be achieved by movement of the scanning element 24. The same preferably also applies for the pivoting of the first removal elements 8 about the first pivot axis 9.

FIG. 4 shows a schematic side view of a removal device 1 according to the invention or a baking device according to the invention. In the region upstream of the removal device 1 bakery products 2 are located in the baking moulds 4. In the region of the removal device 1, the bakery products 2 are removed and conveyed to a dispensing surface 5 in order to be able to be removed on this dispensing surface 5. In the present embodiment and view, the axis of rotation 6 of the rotary unit 7 runs in a projecting manner. The pivot axes 9, 13, in particular the front pivot axis 9 of the first rotary link 18 in this view, also runs in a projecting manner.

The first rotary link 18 comprises a first control cam 19. This first control cam 19 is traversed by the first scanning element 20 and thereby scanned. The first control cam 19 comprises a first control cam section 25 and a second control cam section 26, where the mean radius 27 of the first control cam section 25 is smaller than the mean radius 48 of the second control cam section 26. At the transition between the two control cam sections 25, 46, a first transition section 28 and a second transition section 29 are provided. In particular in the region of these transition sections 28, 29, a relative movement of the scanning element with respect to the rotary unit, is accomplished, for example, a movement in the radial direction of the rotary unit, with the result that the removal elements are moved. As can be deduced from the preceding figures, according to the present embodiment the control device 17 comprises a plurality of rotary links. In particular, two rotary links 18, 22 are provided on both sides of the rotary unit 7. The first rotary link 18 is adapted to control and in particular move the first removal elements 8. The second rotary link 22 is adapted to control and in particular move the second removal elements 12. Along the circumferential circle of the turned rotary unit 7, the first removal elements 8 of a single removal gripper 14 have a certain distance from the second removal elements 12. Optionally the scanning elements 20 and 24 also have a certain distance from one another along a circumferential circle. In order to compensate for this distance, in particular in order to achieve a simultaneous movement of the first and the second removing elements 8, 12, the control cams 19, 23 or the transition sections 28, 33 and 29, 34 can also have a certain offset with respect to one another.

FIG. 5 shows a schematic view of the design of a possible embodiment of the control cams. The first control cam 19 comprises a first cam section 25 and a second cam section 26. The first control cam section 25 has a mean radius 27 which is smaller than the mean radius 48 of the second control cam section 26 of the first control cam 19. Preferably the first scanning element 20 has a normal distance 21 from the first pivot axis 9. This distance is preferably configured as a lag. As a result, the first removal elements 8 are located in their extended position in the region of the first control cam section 25 and in their retracted position in the second control cam section 26. The second control cam 23 also comprises a first control cam section 30 and a second control cam section 31. The mean radius 32 of the first control cam section 30 is smaller than the mean radius 49 of the second control cam section 31. Furthermore, a first transition section 33 and 34 is provided, The first control cam 19 also has transition sections 28 and 29. The second scanning elements 24 also have a normal distance 47 to the pivot axis 13. This normal distance is preferably also configured as a lag. As a result of the arrangement of the rotary link on the other side of the rotary unit 7, the second rotary link 22 optionally has the converse effect to the first rotary link 18. In the second control cam 23, the second removal elements 12 are in their retracted position in the region of the first control cam section 30 and in their extended position in the region of their second control cam section 31.

The transition sections of the two control cams can be arranged offset with respect to one another. By this means different effects can be accomplished. If the distance of the offset for example, corresponds to the distance of the scanning elements, a simultaneous opening or closing of the elements of a removal gripper can be accomplished. For dispensing to the dispensing surface 5, for example, the front part of the removal gripper 14 in the direction of rotation or its removal elements can initially be conveyed into the retracted position in order to firstly release the bakery products 2 in the front region in order to then retract the removal elements in the rear region.

FIG. 6 shows a schematic sectional view of an embodiment of a removal device 1 according to the invention. optionally the removal device 1 corresponds to the removal devices from FIGS. 1, 2, 3, 4 and/or 5.

The removal elements 8, 12 are preferably arranged pivotably about a pivot axis 9, 13. The scanning elements 20, 24 have a normal distance 21, 47 from the pivot axis. As a result, the removal elements 8, 12 can be pivoted. Preferably a plurality of first removal elements 8 are arranged on a first removal bar 37. Optionally a plurality of first removal elements 8 are connected to one another by a removal bar 37. A plurality of first removal elements 8 can be moved by movement of this removal bar 37. The second removal elements 12 can also be provided on a second removal bar 38. Thus, bar grippers 39 can be formed along a parallel to the axis of rotation 6 of the rotary unit 7. The removal bars 37, 38 are preferably mounted rotatably or pivotably about the pivot axes 9, 13 on the rotary unit 7. The removal elements 8, 12 are preferably rigidly attached to the removal bars 37, 38. By pivoting the removal bars about their pivot axes 9, 13, the movement of the removal elements 8, 12 can thus be accomplished.

Optionally, in all embodiments a plurality of removal elements are connected by respectively one removal bar along a parallel to the axis of rotation. A bar gripper 39 can thus be formed by the provision of two parallel removal bars. Optionally a plurality of bar grippers 39 are disposed along the circumference of the rotary unit 7.

FIG. 7a shows one embodiment of a possible removal element 8, 12. The removal element comprises a bent, needle-shaped body. In particular, the removal element comprises a tip 15. This tip 15 is optionally bulbously ground. The tip 15 is in particular adapted to prick into the bakery product 2. The tips 15 are in particular disposed at the free ends or at the free end of the removal elements. At the other ends thereof, they can, for example, be connected to a removal bar.

Optionally the removal element 8, 12 is configured according to FIG. 7b. This in turn comprises a tip 15. In addition, a stop 51 can also be provided. This stop 51 prevents, for example, the tip 15 from being able to penetrate too deeply into the bakery product 2. The tips 15 are in particular disposed at the free ends or at the free end of the removal elements. At the other ends thereof, they can, for example, be connected to a removal bar.

FIG. 7c shows a further embodiment in which the removal elements are connected in one piece to a removal bar. For example, first removal elements 8 are connected to a first removal bar 37. Optionally a plurality of tips 15 are provided per first removal element 8. Such a configuration can be present in all embodiments. Thus, in all embodiments a plurality of tips can be provided per removal element. Optionally in all embodiments a plurality of removal elements can also be connected to one another via a removal bar. Optionally in all embodiments the removal elements can be connected in one piece to the removal bar. Optionally the removal elements are connected positively or non-positively to the removal bar. For example, this connection can be made by means of clamp connections, plug connections or similar connections.

Seamlessly bonded connections such as, for example, adhesive connections or welded connections can also be provided for fastening the removal elements on the removal bar.

Subsequently an exemplary method for the production and removal of one or a plurality of bakery products by a removal device according to the invention or a baking device according to the invention is described.

In a first step a dough or a baking mass is applied to a pre-heated or hot baking tong. The baking tong preferably comprises cavities which, in particular in the closed position but also in the open position, form a baking mould. A dough or a baking mass to produce the bakery products is introduced into this baking mould. This is preferably accomplished in the loading device.

Optionally the bakery product comprises a filled bakery product. In this case, a filling device is provided, The filling can, for example, be achieved by applying centrally a predetermined amount of a filling, for example, a cream to the dough located in the open baking tong. Optionally both baking plates of the baking tong are filled at least partially with a dough in order to form two dough moulds. In a further step the baking tong is closed. As a result, the filling, in particular the cream filling is enclosed between the two dough moulds. In a subsequent baking step the two dough moulds are baked together so that a filling space is formed.

Optionally the filling is inserted into the centre of a dough mould by injection. The bakery product is preferably baked in a closed baking mould so that the filling is also entirely enclosed.

In the baking step the baking mould is conveyed through a preferably heat-insulated baking chamber. In this case, the baking mould or the baking tong is conveyed along an upper first conveying surface to a rear deflection point, to a lower second conveying surface, to a front deflection point and there again to the first upper conveying surface. Along this path, in particular along the first upper conveying surface, a device for opening the baking tongs or the baking moulds is then provided. In this region the baking tong is opened so that the finished bakery product can be removed. The device according to the invention is provided for removal of the bakery products from the baking mould. This preferably comprises a rotary unit. The rotary unit rotates about an axis of rotation so that the bakery products can be removed from the baking mould by rotation of the rotary unit. To this end, in a first preceding step the removal elements are brought into a retracted position. These removal elements are then turned or moved in the direction of that baking mould from which the bakery product is to be removed. When the removal elements have arrived in the region of the baking mould, the control device is actuated whereby the removal elements are moved from the retracted position into an outwardly extended position. A removal gripper is formed by the pairwise interaction of the two removal elements. At least one of the two removal elements has a tip which is pricked into the bakery product to be removed. The tip of the at least one removal element is however only pricked so far that the filling space or the filling is not perforated. Preferably two receiving elements on both sides of the bakery product are pricked into this. However, the pricking movement of the removal elements is stopped before these penetrate into the filling space. The rotary unit is then turned further so that the bakery product is raised through the circular orbit of the removal gripper and in particular is removed from the baking mould. As a result, the removed bakery product is conveyed further along this orbit until it is located in the region of the dispensing surface. In this region, the removal elements are again brought into a retracted position whereby the tips of the removal elements or the individual tip of the removal elements are pulled from the bakery product. The bakery product is thereby released from the rotary unit and can be removed over the dispensing surface.

The removal gripper which has deposited the bakery product on the dispensing surface then arrives at another baking mould, from which a bakery product can again be removed by extending the removal elements.

Preferably a plurality of removal grippers are actuated so that a plurality of adjacently disposed bakery products can be removed from a baking mould or from a plurality of baking moulds. Preferably a plurality of such bar grippers are arranged along the circumference of the rotary unit.

Preferably the bakery products are removed continuously and during a continuous further movement of the bakery products from the baking moulds. To this end the rotary unit is preferably rotated continuously. The baking mould or the baking moulds are further preferably moved continuously.

Optionally in all embodiments the rotary links can be configured as endless links and in particular as continuously scanned endless links. Optionally all the embodiments of the removal device are adapted to remove filled bakery products with a filling provided inside the bakery product in a filling space free from perforation, i.e. to remove them from a baking mould without perforating the filling space.

Optionally all FIGS. 1 to 4 show a single embodiment of the invention.

### REFERENCE LIST

1. Removal device
2. Bakery product
3. Conveying surface of baking moulds
4. Baking mould
5. Dispensing surface
6. Axis of rotation of rotary unit
7. Rotary unit
8. First removal element
9. First pivot axis
10. Retracted position
11. Extended position
12. Second removal element
13. Second pivot axis
14. Removal gripper
15. Tip of removal element
16. Distance between the tips
17. Control device
18. First rotary link
19. First control cam
20. First scanning element
21. Normal distance between first scanning element and first pivot axis
22. Second rotary link
23. Second control cam
24. Second scanning element
25. First control cam section of first control cam
26. Second control cam section of first control cam
27. Mean radius of first control cam section of first control cam
28. First transition section of first control cam
29. Second transition section of first control cam
30. First control cam section of second control cam
31. Second control cam section of second control cam
32. Mean radius of first control cam section of second control cam
33. First transition section of second control cam
34. Second transition section of second control cam
35. Distance of offset
36. Distance of first scanning element to second scanning element
37. First removal bar
38. Second removal bar
39. Bar gripper
40. Plate body
41. Opening
42. Housing
43. Machine frame
44. Baking tong
45. Loading device
46. Baking chamber
47. Normal distance between second scanning element and second pivot axis
48. Mean radius of second control cam section of first control cam
49. Mean radius of second control cam section of second control cam
50. Filling device
51. Stop

1-35. (canceled)

36. A removal device for continuous removal of filled bakery products from baking molds moved along a conveying surface and for continuous transport of the bakery products to a dispensing surface, the removal device comprising:
a rotary unit mounted rotatably about an axis of rotation and being driven;
a first removal element disposed on said rotary unit and being co-rotated with said rotary unit, said first removal element is mounted movably about a first pivot axis, with respect to said rotary unit, so that said first removal element is brought from a retracted position into an outwardly extended position;
a second removal element disposed on said rotary unit and being co-rotated with said rotary unit, said second removal element is mounted movably about a second pivot axis, with respect to said rotary unit, so that said second removal element can be brought from the retracted position into the outwardly extended position;
said first removal element and said second removal element in pairs forming a removal gripper; and
a control device for moving said first and second removal elements from the retracted position into the outwardly extended position and from the outwardly extended position into the retracted position and for opening and closing said removal gripper, said control device having a first rotary link with a first control cam and a first scanning element guided along said first control cam, said first scanning element having a normal distance namely a lag with respect to the first pivot axis and is connected to said first removal element so that as a result of movement of said first scanning element said first removal element is movable from the retracted position into the outwardly extended position and from the outwardly extended position into the retracted position.

37. The removal device according to claim 36, wherein said control device contains a second rotary link with a second control cam and a second scanning element guided along said second control cam and said second scanning element has a normal distance namely a lag with respect to the second pivot axis and is connected to said second removal element so that as a result of movement of said second scanning element said second removal element is movable from the retracted position into the outwardly extended position and from the outwardly extended position into the retracted position.

38. The removal device according to claim 36, wherein one of said first and second removal elements has a free end with a tip or that both of said first and second removal elements each have said tip at free ends thereof, wherein said tip is adapted to prick into the filled bakery product to be removed.

39. The removal device according to claim 38, wherein a distance between said tip of said first removal element and said tip of said second removal element in the outwardly extended position is greater than zero so that said tips neither cross nor contact during extension and are pricked into the filled bakery product at a distance from a cream filling of the bakery product.

40. The removal device according to claim 36, wherein one of said first and second removal elements in the outwardly extended position points in a direction of rotation of said rotary unit and that said other removal element in the outwardly extended position points contrary to the direction of rotation of said rotary unit so that said first and second removal elements point towards one another in the outwardly extended position.

41. The removal device according to claim 38, wherein said tip of one of said first and second removal elements in the outwardly extended position points substantially in a tangential direction of said rotary unit or that said tips of said first and second removal elements in the
outwardly extended position point substantially in the tangential direction of said rotary unit.

42. The removal device according to claim 36, wherein said first removal element is disposed pivotably about the first pivot axis with respect to said rotary unit, wherein the first pivot axis is disposed at a distance from the axis of rotation of said rotary unit on said rotary unit and/or that said second removal element is disposed pivotably about the second pivot axis with respect to said rotary unit, wherein the second pivot axis is disposed at a distance from the axis of rotation of said rotary unit on said rotary unit and that the first pivot axis and the second pivot axis are disposed in parallel at a distance from one another on said rotary unit.

43. The removal device according to claim 36, wherein at least one of the first pivot axis or the second pivot axis is disposed parallel at a distance from the axis of rotation of said rotary unit so that said first and second removal elements of said removal gripper are disposed movably with respect to one another in a gripper-like manner along a normal plane of the axis of rotation of said rotary unit in opposite directions and that said first and second removal elements of said removal gripper optionally run along the normal plane of the axis of rotation of said rotary unit.

44. The removal device according to claim 37, wherein said first control cam has a first control cam section, a first transition section, a second transition section and a second control cam section, wherein a mean radius of said first control cam section is smaller than a mean radius of said second control cam section, and at a transition from said first control cam section to said second control cam section said first transition section connects said first and second control cam sections and at a transition from said second control cam section to said first control cam section said second transition section connects said first and second control cam sections.

45. The removal device according to claim 44, wherein:
said second control cam has a first control cam section, a first transition section, a second transition section and a second control cam section; and
a mean radius of said first control cam section is smaller than a mean radius of said second control cam section, and at a transition from said first control cam section to said second control cam section said first transition section connects said first and second control cam sections and at a transition from said second control cam section to said first control cam section said second transition section connects said first and second control cam sections.

46. The removal device according claim 45, wherein for removal of the filled bakery products one of said first and second transition sections of said first control cam and one of said first and second transition sections of said second control cam are disposed offset with respect to one another in a circumferential direction of said rotary unit, wherein a distance of said offset substantially corresponds to a distance of said first scanning element from said second scanning element so that said first and second removal elements of said removal gripper are moved or pivoted simultaneously with respect to one another in order to close said removal gripper.

47. The removal device according to claim 45, wherein for dispensing of the filled bakery products onto the dispensing surface one of said first and second transition sections of said first control cam and one of said first and second transition sections of said second control cam are disposed with respect to one another in a circumferential direction of said rotary unit in such a manner that a front removal element in a direction of rotation of said rotary unit will be or is moved before a rear removal element in the direction of rotation of said rotary unit from the outwardly extended position into the retracted position.

48. The removal device according to claim 36, wherein:
said first removal element is one of a plurality of first removal elements connected to one another via a first removal bar; and
said second removal element is one of a plurality of second removal elements connected to one another via a second removal bar.

49. The removal device according to claim 37, wherein:
said first removal element is one of a plurality of first removal elements connected to one another via a first removal bar;
said second removal element is one of a plurality of second removal elements connected to one another via a second removal bar;
said first removal bar is connected pivotably about the first pivot axis to said rotary unit and is pivotable with respect to said rotary unit by means of said first scanning element of said control device; and
said second removal bar is connected pivotably about the second pivot axis to said rotary unit and is pivotable with respect to said rotary unit by means of said second scanning element of said control device.

50. The removal device according to claim 48, wherein said first removal elements connected and driven by means of said first removal bar and said second removal elements connected and driven by means of said second removal bar together form a bar gripper for the removal of a plurality of filled bakery products and that a plurality of bar grippers are provided along the circumferential direction of said rotary unit.

51. The removal device according to claim 36, further comprising at least one plate body rigidly connected at an outer region of said rotary unit, said plate body has openings formed therein for passing through said first and second removal elements and that said plate body is a single curved plate body forming a housing.

52. The removal device according to claim 36, further comprising a plurality of plate bodies rigidly connected at an outer region of said rotary unit, said plate bodies having openings formed therein for passing through said first and second removal elements and that said plurality of plate bodies together forming a housing.

53. A baking device for producing bakery products including cream-filled bakery products, the baking device comprising:
a machine frame;
a continuously moving endless conveyor circulating in a longitudinal direction of said machine frame and having a conveying surface;
a loading device;
a baking chamber;
a removal device;
baking molds having baking tongs which can be opened and closed and are movable on said continuously moving endless conveyor along said conveying surface from said loading device through said baking chamber and to said removal device;
a dispensing surface for removal of the bakery products from the baking device;
said removal device for a continuous removal of the cream-filled bakery products from said baking molds and for a continuous transport of the bakery products to said dispensing surface containing:
a rotary unit mounted rotatably about an axis of rotation and being driven;
a first removal element disposed on said rotary unit and being co-rotated with said rotary unit, said first removal element is mounted movably about a first pivot axis, with respect to said rotary unit, so that said first removal element is brought from a retracted position into an outwardly extended position;
a second removal element disposed on said rotary unit and being co-rotated with said rotary unit, said second removal element is mounted movably about a second pivot axis, with respect to said rotary unit, so that said second removal element can be brought from the retracted position into the outwardly extended position;
said first removal element and said second removal element in pairs forming a removal gripper; and
a control device for moving said first and second removal elements from the retracted position into the outwardly extended position and from the outwardly extended position into the retracted position and for opening and closing said removal gripper, said control device having a first rotary link with a first control cam and a first scanning element guided along said first control cam and said first scanning element has a normal distance namely a lag with respect to the first pivot axis and is connected to said first removal element so that as a result of movement of said first scanning element said first removal element is movable from the retracted position into the outwardly extended position and from the outwardly extended position into the retracted position.

54. The baking device according to claim 53, wherein a rotation of said rotary unit is synchronized with a movement of said baking molds so that a speed of said first and second removal elements in a region of said baking molds is substantially the same as a speed of said baking molds.

55. The baking device according to claim 53, wherein said rotary link of said removal device is connected rigidly to said machine frame.

56. The baking device according to claim 53, wherein said removal gripper is one of a plurality of removal grippers closed in a region directly upstream of said dispensing surface and said removal grippers are open in a region directly downstream of said dispensing surface so that at least one bakery product is dispensed by said removal grippers onto said dispensing surface.

57. The baking device according to claim 56, wherein said removal grippers are open in the region directly upstream of said baking mold and that said removal grippers are closed in the region directly downstream of said baking mold so that the bakery products are removed by at least one of said removal grippers from said baking mold.

58. A method for producing and continuous removal of filled bakery products from baking molds moved along a conveying surface and for a continuous transport of the filled bakery products to a dispensing surface, which comprises the steps of:
turning a rotary unit about its axis of rotation;
retracting two removal elements into a retracted position;
turning the removal elements in a direction of a baking mold from which a bakery product is to be removed;
actuating a control device when the removal elements have arrived in a region of the baking mold so that the removal elements are moved from a retracted position into an outwardly extended position;
pricking a tip of:
at least one removal element into the bakery product through movement of the removal element; or
two removal elements disposed on both sides of the bakery product into the bakery product through movement of the removal elements;
stopping a pricking movement of the removal elements before they penetrate into a filling space so that the filling space is not perforated;
turning the rotary unit further so that the bakery product is raised on an orbit of the removal elements and is removed from the baking mold;
conveying a removed bakery product further along the orbit until it is disposed in a region of the dispensing surface; and
retracting the removal elements into the retracted position whereby the tips of the removal elements are pulled from the bakery product so that the bakery product is released from the rotary unit and the bakery product can be removed over the dispensing surface.

59. The method according to claim 58, which further comprises:
applying one of dough or a baking mass to two baking plates of an opened baking tong;
applying a filling centrally to at least one baking plate of the baking tong and to the dough applied to the baking plate or to the baking mass applied to the baking plate;
closing the baking tong, whereby the filling is enclosed between two dough molds or two baking mass molds;
joining the two dough molds or the baking mass molds by baking in a baking chamber; and
removing the filled bakery products thus formed with the filling space disposed therein.
